(19) United States
(12) Patent Application Publication
(10) Pub. No.: US 2005/0177290 A1
(43) Pub. Date: Aug. 11, 2005

(54) System or method for classifying target information captured by a sensor

(76) Inventor: Michael E. Farmer, West Bloomfield, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/776,072

(22) Filed: Feb. 11, 2004

(51) Int. Cl. G06F 17/00

(52) U.S. Cl. 701/45; 180/271; 280/735

(57) ABSTRACT

The disclosure describes a system and method for classifying information relating to target attributes that are captured by a sensor (collectively “classification system”). A wide variety of sensors, classification categories (including potentially classes and groups of classes), targets, and purposes can influence the processing performed by the classification system. The classification system is not forced to arbitrarily identify a single class as the appropriate classification if two or more classes cannot be adequately distinguished from one another given the particular target attributes and processing results. The classification system can generate a classification relating to a group of classes, with the group including one, two, or even more than two classes, if such a conclusion is appropriate. Historical attributes, environmental factors, relevant events and the plausibility of transitions from one class to another, can be incorporated into the classification process.

### RELATED APPLICATIONS

The following applications are hereby incorporated by reference in their entirety: “A RULES-BASED OCCUPANT CLASSIFICATION SYSTEM FOR AIRBAG DEPLOYMENT,” Ser. No. 09/870,151, filed on May 30, 2001; “IMAGE PROCESSING SYSTEM FOR DYNAMIC SUPPRESSION OF AIRBAGS USING MULTIPLE MODEL LIKELIHOODS TO INFER THREE DIMENSIONAL INFORMATION,” Ser. No. 09/901,805, filed on Jul. 10, 2001; “IMAGE PROCESSING SYSTEM FOR ESTIMATING THE ENERGY TRANSFER OF AN OCCUPANT INTO AN AIRBAG,” Ser. No. 10/006,564, filed on Nov. 5, 2001; “IMAGE SEGMENTATION SYSTEM AND METHOD,” Ser. No. 10/023,787, filed on Dec. 17, 2001; “IMAGE PROCESSING SYSTEM FOR DETERMINING WHEN AN AIRBAG SHOULD BE DEPLOYED,” Ser. No. 10/052,152, filed on Jan. 17, 2002; “MOTION-BASED IMAGE SEGMENTOR FOR OCCUPANT TRACKING,” Ser. No. 10/269.237, filed on Oct. 11, 2002; “OCCUPANT LABELING FOR AIRBAG-RELATED APPLICATIONS,” Ser. No. 10/269,308, filed on Oct. 11, 2002; “MOTION-BASED IMAGE SEGMENTOR FOR OCCUPANT TRACKING USING A HAUSDORF-DISTANCE HEURISTIC,” Ser. No. 10/269,357, filed on Oct. 11, 2002; “SYSTEM OR METHOD FOR SELECTING CLASSIFIER ATTRIBUTE TYPES,” Ser. No. 10/375,946, filed on Feb. 28, 2003; “SYSTEM AND METHOD FOR CONFIGURING AN IMAGING TOOL,” Ser. No. 10/457,625, filed on Jun. 9, 2003; “SYSTEM OR METHOD FOR SEGMENTING IMAGES,” Ser. No. 10/619,035, filed on Jul. 14, 2003; “SYSTEM OR METHOD FOR CLASSIFYING IMAGES,” Ser. No. 10/625,208, filed on Jul. 23, 2003; “SYSTEM OR METHOD FOR IDENTIFYING A REGION-OF-INTEREST IN AN IMAGE,” Ser. No. 10/663,521, filed on Sep. 16, 2003; “DECISION ENHANCEMENT SYSTEM FOR A VEHICLE SAFETY RESTRAINT APPLICATION,” Ser. No. 10/703,957, filed on Nov. 7, 2003; and “DECISION ENHANCEMENT SYSTEM FOR A VEHICLE SAFETY RESTRAINT APPLICATION,” Ser. No. 10/703,345, filed on Nov. 7, 2003.

### BACKGROUND OF THE INVENTION

The invention relates generally to systems and methods for classifying information captured by one or more sensors (collectively “classification system,” “classifier” or simply the “system”).

Human beings are remarkably adept at categorizing information in a variety of different forms, such as images captured by cameras and other forms of sensors. Although automated systems have many advantages over human beings, human beings maintain a remarkable superiority in classifying information captured by various sensors. For example, if a person watches video footage of a human being pulling off a sweater over their head, the person is unlikely to doubt the continued existence of the human being's head simply because the head is temporarily covered by the sweater. In contrast, an automated system in that same circumstance may have great difficulty in determining whether a human being is within the image due to the absence of a visible head. In the analogy of not seeing the forest for the trees, automated systems are excellent at capturing detailed information about various trees in the forest, but human beings are much better at classifying the area as a forest. Moreover, human beings are also better at integrating current data with past data, and in realizing the inherent limits of the powers of observation in a particular context. For example, a human being can take into consideration that they did not have a particularly good view of the given target by the sensor.

Advancements in the capture and manipulation of digital images continue at a rate that far exceeds improvements in classification technology. The performance capabilities of sensors, such as digital cameras and digital camcorders, continue to rapidly increase while the costs of such devices continue to decrease. Similar advances are evident with respect to computing power generally. Such advances continue to outpace developments and improvements with respect to classification systems, and other technologies relating to the processing of the information captured by the various sensor systems.

There are several limitations in existing classification systems that inhibit the effectiveness of those systems. Many classifiers are arbitrarily required to make classification distinctions beyond the capacity of the particular information captured by the sensor or by the processing performed using such information. Situations can and do occur where the particular target attributes captured by the sensor indicate the target is roughly equally likely to be two or more different classes. Prior art classifiers typically respond to such a situation by either (1) giving up and failing to provide a final determination of any type; or (2) arbitrarily choosing one of the likely classes despite the high likelihood that one or more other classes may be the true classification of the target. Thus, prior art classification systems fail to utilize information and generate conclusions consistent with the level of detail or level of abstraction that corresponds to the processing of the classification system.

Another weakness that is typical to prior art classifiers is the failure of prior art classifiers to properly account for changes in the classification, including environmental factors, historical attributes, and the occurrence of relevant events. For example, in the context of an occupant classifier used in the context of an automated safety restraint application, a human being would realize that an adult is unlikely to have become a child. Human beings are not fooled by such a situation because human beings can apply contextual and evidential reasoning to the information being processed. Traditional classification applications fail to adequately integrate such factors into the processing of the information captured by the sensor.

### SUMMARY OF INVENTION

The invention relates generally to systems and methods for classifying information captured by one or more sensors (collectively “classification system,” “classifier,” or simply the “system”). The system can be used in conjunction with a wide variety of different sensor configurations, sensor types, target types, category relationships (including various group/class relationships), environments, implementation mechanisms, and purposes.

Instead of forcing the classifier to single out a particular class as the appropriate classification in a context where two or more classes have a substantial likelihood of being true, the system can acknowledge that a set or group of multiple classes cannot be confidently distinguished with respect to the particular information being processed. In such a context, the resulting classification can point to one or more groups of classes (with different groups possessing classes), with potentially greater accuracy.

The system can also incorporate environmental factors, historical attributes, and other relevant events into the processing of the information captured by the sensor. For example, in certain circumstances, it may be desirable to give importance to a prior classification, while in other circumstances, it may be inappropriate to incorporate other types of historical information.

A grouping subsystem can be used to create, delete, and update the creation of the various classes that can be used to classify the target information. Target information is the information that relates to the item, object, space, or organism (collectively “target”) that relates to the purpose and observation of the sensor.

A selection subsystem can be used to generate, select, or identify the appropriate classification from the grouping subsystem that describes the target information captured by the one or more sensors. The selection subsystem can include historical attributes, environmental factors, and the occurrence of relevant contextual events into the classification determination process.

In some embodiments, belief metrics, plausibility metrics, incoming probability masses, past probability masses, and various event-driven processing can be used by the selection subsystem to generate classifications. In other embodiments, such factors may be processed by a decision enhancement subsystem, a subsystem that can enhance the decisions of the selection subsystem.

The present invention will be more fully understood upon reading the following detailed description in conjunction with the accompanying drawings.

### BRIEF DESCRIPTION OF THE DRAWINGS

FIG. 1 is an input/output diagram illustrating one example of an embodiment of a classification system.

FIG. 2a is a hierarchy diagram illustrating one example of the different types of groups that can incorporated into the processing performed by the classification system.

FIG. 2b is a hierarchy diagram illustrating various examples of single-class groups that can be incorporated into the processing performed by the classification system.

FIG. 2c is a hierarchy diagram illustrating various examples of double-class groups that can be incorporated into the processing performed by the classification system.

FIG. 2d is a hierarchy diagram illustrating various examples of triple-class groups that can be incorporated into the processing performed by the classification system.

FIG. 2e is a hierarchy diagram illustrating an example of a quadruple-class group that can be incorporated into the processing performed by the classification system.

FIG. 3a is a diagram illustrating an example of a rear-facing infant seat (RFIS) classification in a vehicle safety restraint application embodiment of the classification system.

FIG. 3b is a diagram illustrating an example of a child classification in a vehicle safety restraint application embodiment of the classification system.

FIG. 3c is a diagram illustrating an example of an adult classification in a vehicle safety restraint application embodiment of the classification system.

FIG. 3d is a diagram illustrating an example of an empty classification in a vehicle safety restraint application embodiment of the classification system.

FIG. 4 is a block diagram illustrating an example of a subsystem-level view of an embodiment of the classification system.

FIG. 5 is a block diagram illustrating an example of a subsystem-level view of an embodiment of the classification system that includes an enhancement subsystem.

FIG. 6 is flow chart diagram illustrating an example of a process for classifying target information that is captured by a sensor.

FIG. 7 is a flow chart diagram illustrating an example of a process for implementing the classification system.

FIG. 8 is a flow chart diagram illustrating a detailed example of the classification system in a vehicle safety restraint application embodiment.

### DETAILED DESCRIPTION

The invention relates generally to systems and methods for classifying information captured by one or more sensors (collectively “classification system,” “classifier,” or simply the “system”). The system can be used in conjunction with a wide variety of different: sensor configurations; sensor types; target types; category relationships (including various group/class relationships); environments; implementation mechanisms; and purposes.

The classification system can be used in a wide variety of different applications, including but not limited to the following:
airbag deployment mechanisms and other vehicle safety restraint applications (collectively “safety restraint applications”) can utilize the classification system to distinguish between occupants where deployment would be desirable (e.g. the occupant is an adult), and occupants where deployment would be undesirable (e.g. an infant in a child seat);
security applications may potentially utilize the classification system to determine whether a motion sensor was triggered by a human being, an animal, or even inorganic matter;
radiological applications can potentially incorporate the classification system to classify x-ray results, automatically identifying types of tumors and other medically-relevant phenomenon;
security/identification applications can potentially utilize the classification system to match images with the identities of specific individuals; and
navigation applications may use the classification system to identify potential obstructions on the road, such as other vehicles, pedestrians, animals, construction equipment, and other types of obstructions.

The classification system is not limited to the examples listed above. Virtually any application that uses some type of image as an input can benefit from incorporating the classification system. Moreover, the system is not limited to applications where the sensor is an image-based sensor. The classification system can be used in conjunction with sensor readings where the readings are converted into an image format even if the sensor capturing the readings have nothing to do with light of any visible or invisible wavelength.

The system does not force the selection of a single classification if two or more classes have a roughly equal likelihood of being true, or even if the second-most likely conclusion has a material probability of being accurate. In such a context, the system can acknowledge that a finite set or group of multiple classes cannot be confidently distinguished with respect to the particular information being processed.

The system can also incorporate environmental factors, historical attributes, and other relevant events into the processing of the information captured by the sensor. For example, in certain circumstances, it may be desirable to give importance to prior classifications, while in other circumstances, it may be inappropriate to incorporate historical information.

### Introduction of Elements

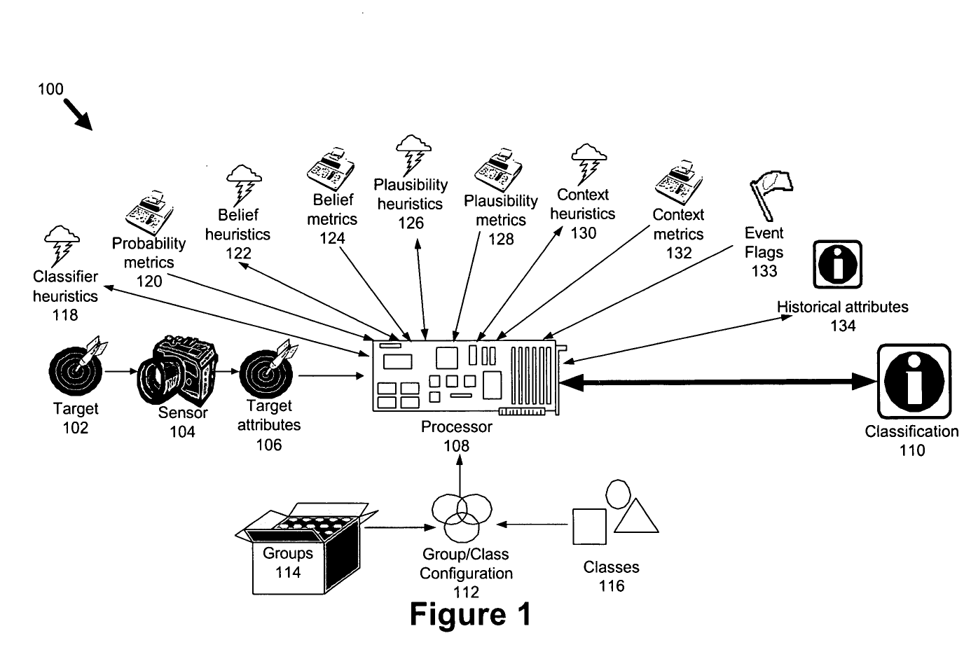

FIG. 1 is an input/output diagram illustrating one example of an embodiment of a classification system 100. Different embodiments of the system 100 can involve a wide variety of different types and numbers of inputs. The primary output of the classification system 100 is a classification 110. However, the classification 110 can be used as an input for future classifications 110, and many of the inputs to the system 100 can obtain feedback from the classification 110, allowing those components to receive inputs themselves.

A. Target

A target 102 can be any individual or group of persons, animals, plants, objects, spatial areas, or any other focus of interest or attention (collectively “target” 102) that is or are the subject or target of a sensor 104 used by the system 100. The purpose of the classification system 100 is to generate a classification 110 of the target 102 that is relevant to the application incorporating the classification system 100.

The variety of different targets 102 can be as broad as the variety of different applications incorporating the functionality of the classification system 100. As discussed above, the system 100 can be used in a variety of different environments to support a wide variety of different applications. In an embodiment of the system 100 that is utilized by a safety restraint application, the target 102 is an occupant in the seat corresponding to the airbag or other form of safety restraint. Unnecessary deployments and inappropriate failures to deploy the safety restraint can potentially be avoided by providing the safety restraint application with accurate information relating to the type of occupant. For example, the airbag mechanism can be automatically disabled if the occupant of the seat is classified as a child or a rear-facing infant seat (RFIS).

In other embodiments of the system 100, the target 102 may be a human being (various security embodiments), persons and objects outside of a vehicle (various external vehicle sensor embodiments), air or water in a particular area (various environmental detection embodiments), a cancerous tumor in an x-ray (various medical diagnostic embodiments) or potentially any other type of target 102 for which a sensor 104 can capture potentially useful target attributes 106 suitable for a classification determination.

B. Sensor

A sensor 104 can be any type of device used to capture information relating to the target 102 or the area surrounding the target 102. The variety of different types of sensors 104 can vary as widely as the different types of physical phenomenon and human sensation. The type of sensor 104 will often depend on the underlying purpose of the application incorporating the classification system 100. One common category of sensors 104 are image-based sensors, sensors 104 that capture information in the form of an image, such as a video camera or a still-photograph camera (collectively “optical sensors”). Moreover, even sensors 104 not designed to directly utilize a light-based mechanism can be used to capture sensor readings that are transformed into images and subsequently processed by the system 100. Ultrasound pictures of an unborn child are one prominent example of the creation of an image from a sensor 104 that does not involve light-based or visual-based sensor data. Such sensors 104 can be collectively referred to as non-optical sensors 104. Optical sensors 104 and non-optical sensors 104 that derive images or otherwise result in images being generated from the sensor readings can be processed by the classification system 100, and can be referred to as image-based sensors 104.

The system 100 can incorporate a wide variety of sensors (collectively “optical sensors”) 104 that capture light-based or visually-based sensor data. Optical sensors 104 capture images of light at various wavelengths, including such light as infrared light, ultraviolet light, x-rays, gamma rays, light visible to the human eye (“visible light”), and other optical images. In many embodiments, the sensor 104 may be a video camera. In a preferred vehicle safety restraint embodiment such as an airbag suppression application where the system 100 monitors the type of occupant, the sensor 104 can be a standard digital video camera. Such cameras are less expensive than more specialized equipment, and thus it can be desirable to incorporate “off the shelf” technology.

Non-optical sensors 104 focus on different types of information, such as sound (“noise sensors”), smell (“smell sensors”), touch (“touch sensors”), or taste (“taste sensors”). Sensors can also target the attributes of a wide variety of different physical phenomenon such as weight (“weight sensors”), voltage (“voltage sensors”), current (“current sensor”), radiation (“radiation sensor”) and other physical phenomenon (collectively “phenomenon sensors”).

C. Target Attributes

A target attribute 106 is any “bit” of information that can be obtained relating to the target 102. Thus, target attributes 106 can also be referred to as target information. Target attributes 106 are captured by one or more sensors 104, in the form of various sensor readings. In some embodiments, the format of the target attributes 106 is substantially different than the format in which the sensor 104 collects the information. For example, it is often useful to create various graphical representations of raw data for the purposes of interpretation and utilization.

In the context of an image-based sensor 104, target attributes 106 are captured or immediately converted into the form of an image. Sensors 104 that are not image-based sensors 104 capture target attributes 106 in formats that correspond to the functionality of the sensor 104. In some embodiments, target attributes 106 will also include some information about the area or context surrounding the target 102. For example, a video camera will not typically be able to isolate the pixels representing the human occupant for the pixels representing other aspects of the vehicle environment.

The collection of target attributes 106 can include any information in any format that relates to the target 102 and is capable of being captured by the sensor 104. With respect to embodiments utilizing one or more optical sensors 104, target information is contained in or originates from the target image. Such an image is typically composed of various pixels. With respect to non-optical sensors 104, target information is some other form of representation, a representation that can typically be converted into a visual or mathematical format. For example, physical sensors 104 relating to earthquake detection or volcanic activity prediction can create output in a visual format although such sensors 104 are not optical sensors 104.

In many airbag embodiments and other safety restraint application embodiments, target attributes 106 will be in the form of a visible light image of the occupant in pixels. However, the forms of target information 106 can vary more widely than even the types of sensors 104, because a single type of sensor 104 can be used to capture target information 106 in more than one form. The type of target attributes 106 that are desired for a particular embodiment of the classification system 100 will determine the type of sensor(s) 104 used in the system 100. When the target attributes 106 captured by the sensor 104 are in the form on an image, that image can often also be referred to as an ambient image or a raw image. An ambient image is an image that includes the image of the target 102 as well as the area surrounding the target. A raw image is an image that has been captured by the sensor 104 and has not yet been subjected to any type of processing, such as segmentation processing to better focus on the target 102 and to isolate the target 102 from the area surrounding the target 102. In many embodiments, the ambient image is a raw image and the raw image is an ambient image. In some embodiments, the ambient image may be subjected to types of pre-processing, and thus would not be considered a raw image. Various forms of pre-processing are disclosed in the patent applications referred to below in Section VI titled “RELATED APPLICATIONS.”

In a preferred embodiment of the system 100, target attributes 106 are transmitted by the sensor 104 to a processor 108. In an image-based embodiment of the system 100, the image sent to the processor 108 is typically a digital image. Often in such a context, the target attributes 106 will be broken down into a vector of features (e.g. a vector populated with values relating to relevant target attributes 106). In some embodiments, the sensor 104 can itself perform the process of populating the vector of features. In other embodiments, it is the processor 108 that performs such a function. Attribute vectors are discussed in greater detail in the following patent applications, which are hereby incorporated by reference in their entirety: “A RULES-BASED OCCUPANT CLASSIFICATION SYSTEM FOR AIRBAG DEPLOYMENT,” Ser. No. 09/870,151, filed on May 30, 2001; “OCCUPANT LABELING FOR AIRBAG-RELATED APPLICATIONS,” Ser. No. 10/269,308, filed on Oct. 11, 2002 “SYSTEM OR METHOD FOR SELECTING CLASSIFIER ATTRIBUTE TYPES,” Ser. No. 10/375,946, filed on Feb. 28, 2003; and “SYSTEM OR METHOD FOR CLASSIFYING IMAGES,” Ser. No. 10/625,208, filed on Jul. 23, 2003.

D. Processor

A processor 108 is potentially any type of computer or other device (such as an embedded computer, programmable logic device, or general purpose computer) that is capable of performing the various processes needed for the classification system 100 to receive various inputs, and make a determination with respect to the appropriate classification 110. In some embodiments of the system 100, there may be a combination of computers or other devices that perform the functionality of the processor 108. The programming logic and other forms of processing instructions performed by the processor 108 are typically implemented in the form of software, although they may also be implemented in the form of hardware, or even in a combination of software and hardware mechanisms. The processor 108 can also include the types of peripherals typically associated with computation or information processing devices, such as wireless routers, printers, CD-ROM drives, light pens, etc.

In some embodiments of the system 100, the processor may also be a general purpose computer, such as a desk top computer, a laptop computer, a personal digital assistant (PDA), a mainframe computer, a mini-computer, a cell phone, or some other device.

E. Classification

A classification 110 is potentially any determination made by the classification system 100. Classifications 110 can be in the form of numerical values or in the form of a categorical value relating to a group 114 or class 116 that is believed to categorize the target 102. Classifications 110 relate to the target 102 of the system 100. For example, in a safety restraint application embodiment of the system 100, the classification 110 can be a categorization of the type of occupant. In a preferred embodiment, the system 100 makes a classification 110 determination by evaluating various pre-defined classes 116 and/or pre-defined groups 114 to determine which classes 116 and/or pre-defined groups 114 exhibit attributes indicative of the target 102 as represented in the target attributes 106. Thus, in a preferred embodiment of the system 100, the process of generating the classification 110 is a process of making a selection of a group 114 that is associated with one or more classes 116. In alternative embodiments, some classes 116 and groups 114 may be dynamically created by the system 100 as the system 100 generates empirical data useful to the functionality of the system 100.

In a preferred embodiment of the system 100, the selection of the appropriate classification 110 is made on the basis of a group 114 (group-level classification) instead of a classification 110 for a single specific class 116 (class-level classification). As discussed below, a single group 114 can include as few as one, and as many as all of the classes 116. By making classifications 110 at the level of group-identity rather than class-identity, the system 100 can be better equipped to deal with situations where two or more classes 116 have a relatively equal probability of being accurate or even a context where the second-best determination has a realistic probability of being accurate (collectively a “close call situation”). In a close call situation, the ability to set classifications 110 based on group-identity instead of class-identity eliminates the need to either: (1) give up and fail to provide a final determination of any type because there does not appear to be a single answer; or (2) arbitrarily choose one of the likely classes 116 despite the relatively high likelihood that one or more other classes 116 may be the true classification of the target 102.

F. Group/Class Configuration

The system 100 can use a wide variety of different group/class configurations 112 to support the processing performed by the processor 108. The group/class configuration 112 determines how many groups 114 are processed by the system 100, and the various classes 116 that are associated with those groups 114. The group/class configurations 112 are typically implemented in the data design that is incorporated into the functionality of the processor 108. Such a design can be embodied in a data base, an array, flat files, or various other data structures and data design implementations.

G. Classes

A class 116 represents the most granular and specific characterization or categorization that can be made by system 100. For example, in a preferred embodiment of a vehicle safety restraint embodiment of the system 100, the potential classes 116 will include that of an {adult, a child, a rear-facing infant seat, and an empty seat}. Thus, in such an embodiment, the system 100 could classify one occupant as being an adult, while another occupant could be classified as a child. In alternative vehicle safety restraint embodiments, the library of potential classes 116 could also include a forward-facing child seat, a seat occupied by a box (or some other inanimate object), or any other myriad of potential classification distinctions.

Regardless of the particular environment and embodiment, classes 116 should be defined in light of the purposes of the application employing the use of the classification system 100. The classes 116 used by the system 100 in a particular embodiment should be defined in such a way as to capture meaningful distinctions such that the application using the system 100 can engage in the appropriate automated and non-automated functionality on the basis of the information conveyed by the classification system 100.

Classes 116, and their various potential relationships with groups 114, are discussed in greater detail below.

H. Groups

The group/class configurations 112 used by the system 100 can include a wide variety of different groups 114. Each group 114 is preferably made up of one or more classes 116. Some groups 114 may be made up of only one class 116, while one group 114 within a particular embodiment of the system 100 could be made up of all potential classes 116. Groups 114 can also be referred to as sets (a group 114 is a mathematical set of classes 116), and many implementations of the system 100 will involve processing that utilizes various set theory techniques known in the art of mathematics.

As discussed both above and below, the classifications 110 generated by the system 100 are preferably made at the group-level. This maximizes the value and sophistication of the processing performed in a close call situation, as discussed above.

Groups 114, and their various potential relationships with classes 116, are discussed in greater detail below.

I. Classification Heuristics

A classification heuristic 118 (which can also be referred to as a classifier heuristics 118) is any process, algorithm, or set of implementation instructions that can be implemented by the system 100 to generate the classification 110 from the various inputs. Various different classification heuristics are known in the art. The following patent applications, which are hereby incorporated by reference in their entirety, disclose examples of different classification heuristics: “A RULES-BASED OCCUPANT CLASSIFICATION SYSTEM FOR AIRBAG DEPLOYMENT,” Ser. No. 09/870,151, filed on May 30, 2001; “OCCUPANT LABELING FOR AIRBAG-RELATED APPLICATIONS,” Ser. No. 10/269,308, filed on Oct. 11, 2002; “SYSTEM OR METHOD FOR SELECTING CLASSIFIER ATTRIBUTE TYPES,” Ser. No. 10/375,946, filed on Feb. 28, 2003; “SYSTEM AND METHOD FOR CONFIGURING AN IMAGING TOOL,” Ser. No. 10/457,625, filed on Jun. 9, 2003; “SYSTEM OR METHOD FOR CLASSIFYING IMAGES,” and Ser. No. 10/625,208, filed on Jul. 23, 2003.

The system 100 can incorporate classification heuristics 118 known in the prior art, as well as those classification heuristics 118 disclosed in the patent applications identified above. The system 100 can incorporate multiple different classification heuristics 118 in a weighted fashion. The various classification heuristics 118 can also be used in conjunction with the various belief metrics 124, plausibility metrics 128, and context metrics 132 discussed below.

J. Probability Metrics

Some of the classification heuristics 118 identified above generate one or more probability metrics 120 as a means for quantifying the confidence associated with a particular classification 110. In a preferred embodiment of the system 100, probability metrics 120 are influenced by belief metrics 124, plausibility metrics 128, context metrics 132, event flags 132, and historical attributes 134, as discussed below.

K. Belief Heuristics

A belief heuristic 122 is a type of classification heuristic 118 that generates a belief metric 124, discussed below. The purpose of the belief heuristic 122 is to generate a measurement that relates to the aggregate “support” that exists for a particular group 114 being selected as the classification 110. The belief heuristic 118 can be applied to each potential classification 110 determination, resulting in each potential selection being associated with a belief metric 124. In other embodiments, the belief heuristic 122 may be limited to an initial classification 110 generated by another classification heuristic 118, a prior classification 110, or only a subset of the potential groups 114 available for the purposes of classification determinations. In a preferred embodiment, the belief heuristic 122 incorporates the Dempster-Shafer rules of evidence combination.

L. Belief Metrics

A belief metric 124 is the output generated by the belief heuristic 122. The belief metric 124 is potentially any numerical value (or even a range of numerical values) that illustrates the “support” that exists for a potential classification 110. For the reasons evident below, Belief metrics 124 can be thought of as conservative or “pessimistic metrics” relating to the accuracy of a particular classification 110.

In a preferred embodiment of the system 100, prior classifications 110 are integrated into the process of generating new and updated classifications 110. Thus, an incoming probability mass metric is combined with the past probability mass metric for each group 114 of classes 116. A new mass calculation is preferably performed for each group 114. The m1(A) variable is the prior probability for a particular group classification 110 and the m2(A) variable is the most current probability associated with a particular group classification 110. According to Equation 1:

$$New Mass ( A ) = m1 ( A ) + m2 ( A ) = \frac{\begin{matrix}Sum of all group probabilities overlapping with the classes \\ within the group identified by the parameter ( A )\end{matrix}}{\begin{matrix}1 - Sum of all group probabilities overlapping with the classes \\ not found within the group identified by the parameter ( A )\end{matrix}}$$

In the language of set theory, Equation I is equal to the formula in Equation 2:

$$New Mass ( A ) = \frac{Sum of m1 ( X ) * m2 ( Y ) for all X , Y intersection A}{\begin{matrix}1 - Sum of m1 ( X ) * m2 ( Y ) for all X , Y with \\ empty intersection\end{matrix}}$$

Equation 2 is calculated for each group 114. Different groups 114 involve different numbers of classes 116, so the number of different potential overlap points will vary with respect to Equation 2. “X,Y intersection A” refers to the potential universe of groups that have at least one class 116 that overlaps with the group 114 identified by the input parameter “(A)”. “X,Y with empty intersection” refers to the potential universe of groups that do not have at least one class 116 that overlaps with the group 114 identified by the input parameter “(A)”. The product of “m1(X)*m2(Y)” is the multiplication of overlapping group probabilities which is done at each intersection point. The value of m1(X) relates to the past aggregate probability of all groups that each include a particular class 116 that is also within the group identified by parameter “(A)”. Similarly, the value of m2(Y) relates to the updated probability of all groups that each include a particular class 116 that is also within the group identified by parameter “(A)”.

In a preferred embodiment of the system 100, a “new mass” or probability mass metric is calculated for each group 113, and each group 114 relates to a “set” in the mathematical art of “set theory.” Thus, in a four class embodiment where every possible class 116 combination is differentiated by a different group 114, there will be sixteen distinct groups 114 (including one null group 114 devoid of any classes).

For the purposes of the illustrating the new mass calculation Equation 2 it should be assumed that there are only two classes 116 (class i and Class ii) and three groups (one group including only class i, one group including only class ii, and one group including both i and ii). The variable m1(X) represents the aggregate probabilities of all groups 114 possessing class i. The variable m2(Y) represents the aggregate probabilities of all groups 114 possessing class ii. Once the “new mass” is determined for each class 116, the belief metrics 124 and the plausibility metric 128 (discussed below) can be generated. One example of a belief metric 124 is illustrated in Equation 3:
Belief(A)=sum of m(B) over all subsets B of A

In Equation 3, “Belief(A)” refers to the probability that a particular group 114 is the correct group 114. The input parameter “(A)” refers to a particular group 114. The “m(B)” variable refers to all of the group probabilities relating to classes 116 that are a subset of those classes 116 included in the group 114 for which the belief metric is being calculated. For example, in a two class example mentioned above, if Group I includes Class i and Class ii, Group II includes Class i, and Group III includes Class ii, both Groups II and III are subsets of Group I. In contrast, Class A is not a subset of any other Group. The inability of some groups 114 to be subsets of other groups makes the belief metric of Equation 3 is a conservative indicator of a correct classification 110. The belief metric of Equation 3 can be referred to as a “pessimistic probability metric.”

In some embodiments of the system 100, the belief metric 124 is represented in the form of an interval (a “belief metric interval” or “belief interval”) that incorporates the value of the plausibility metric 128, e.g. Plausibility(A) discussed below, as well as the value of Belief(A) generated from Equation 3. Such an interval is represented in Equation 4:
Belief interval=[Belief(A), Plausibility(A)]
M. Plausibility Heuristics

Plausibility heuristics 126 represent the “flip side” of belief heuristics 122. Plausibility heuristics 126 generate one or more plausibility metric 128 that represent in a numerical fashion, the plausibility of a particular transition from one classification 110 to another classification 110 being plausible. This type of processing can incorporate predefined likelihoods of particular transitions occurring. For example, in a safety restraint embodiment, while it may be very foreseeable for an adult to appear as a child for a period of time, it would be less foreseeable for the transition from adult to RFIS to occur. The plausibility heuristics 126 can incorporate such predefined presumptions and probabilities into the calculation or subsequent modification of the plausibility metrics 128. Each plausibility metric 128 preferably relates to a particular belief metric 124, with both the plausibility metric 128 and the belief metric 124 referring to a particular group 114 with a particular composition of classes 116.

N. Plausibility Metrics

A preferred embodiment of the system 100 applies the Dempster-Shafer rules of evidence combination, as illustrated in Equation 1-4 above for the creation of belief metrics 124 and plausibility metrics 128. Equation 5 and Equation 6 provide as follows with regards to plausibility metrics 128. The value “m(A)” as discussed above, represents the probability that a classification 110 of a particular group 114 would be the correct classification 110.
Basic Probability Assignment(A)=m(A) Equation 5:
Plausibility(A)=1−Belief(A′), where A′=compliment(A) Equation 6:

Thus, the plausibility metric 128 can be represented in the numerical value of the sum of all the evidence that does not directly refute the belief in A. Unlike the belief metric 124 which can be thought of as a “pessimistic value” the plausibility metric 128 can be thought of as an “optimistic value.” Together, the plausibility metric 128 and belief metric 124 provide a desirable way to make classification determinations.

O. Context Heuristics

A context heuristic 130 is a process that impacts the classification 110 indirectly, by obtaining environmental or event-based information that allows the classifier 100 to make a smarter (i.e. more informed) decision than the mathematical analysis of the plausibility heuristic 126, belief heuristic 122, and other classifier heuristics 118 could make on their own. For example, in a safety restraint embodiment, knowledge regarding the opening of a door, the presence or absence of a key in the ignition, the presence or absence of a running engine, and a litany of other considerations may add context to the classification process that can eliminate a variety of potential groups 114 and classes 116 from consideration as potential classifications 110. Context heuristics 130 can generate one or more context metrics 132 and/or result in the setting of various event flags 133. Context heuristics 130 are by definition, context specific, and thus different embodiments of the system 100 can include a wide variety of different context heuristics 130.

P. Context Metrics

A context metric 132 is the result that is generated or outputted by the context heuristic 130. Examples of context metrics 132 can include a numerical value representing the amount of light in the environment, the weight of the occupant or target 102, the speed of the vehicle, etc.

Q. Event Flags

An event flag 133 is similar to a context metric 132 in that both are outputs of the context heuristic 130. Unlike the context metrics 132 that possess a potential wide range of numerical values, the event flags 133 are limited to binary values, such as the open/closed status of a door, the moving/non-moving status of a vehicle, etc. The application of context metrics 132 and events flags 133 are particularly important to the classification system 100 when historical attributes 134 (past classifications 110 and other information) are used to help interpret the present classification 110. Certain context information, such as the opening of a door in a safety restraint application, can result in a tremendously different treatment of historical information, as discussed below.

R. Historical Attributes

Historical attributes 134, such as previous classifications 110, the probability metrics 120 and other metrics relating to those classifications 110, and even prior sensor readings, can potentially be incorporated into current decision making processes. Different applications can make use of different libraries of historical attributes 134. In a preferred embodiment of the system 100, historical attributes can be continuously saved and deleted.

### Group/Class Configurations

The system 100 can use various set theory techniques from the art of mathematics to improve the utility and accuracy of the classifications 110 generated by the system 100. Classifications 110, as discussed above and below, are made at the group-level instead of the class-level. Thus, in the example of a vehicle safety restraint embodiment, the system 100 is not necessarily forced to choose between the class 116 of a child and the class 116 of a RFIS if the two classes 116 have a roughly equal probability of being correct. Instead, the classification 110 can be set to a group 114 that is made up of both the RFIS class 116 and the child class 116.

A. Groups of Varying Specificity

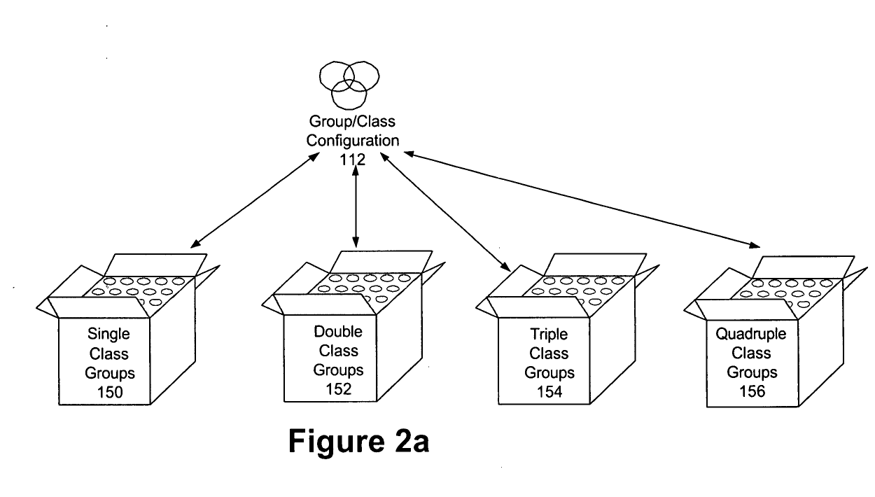

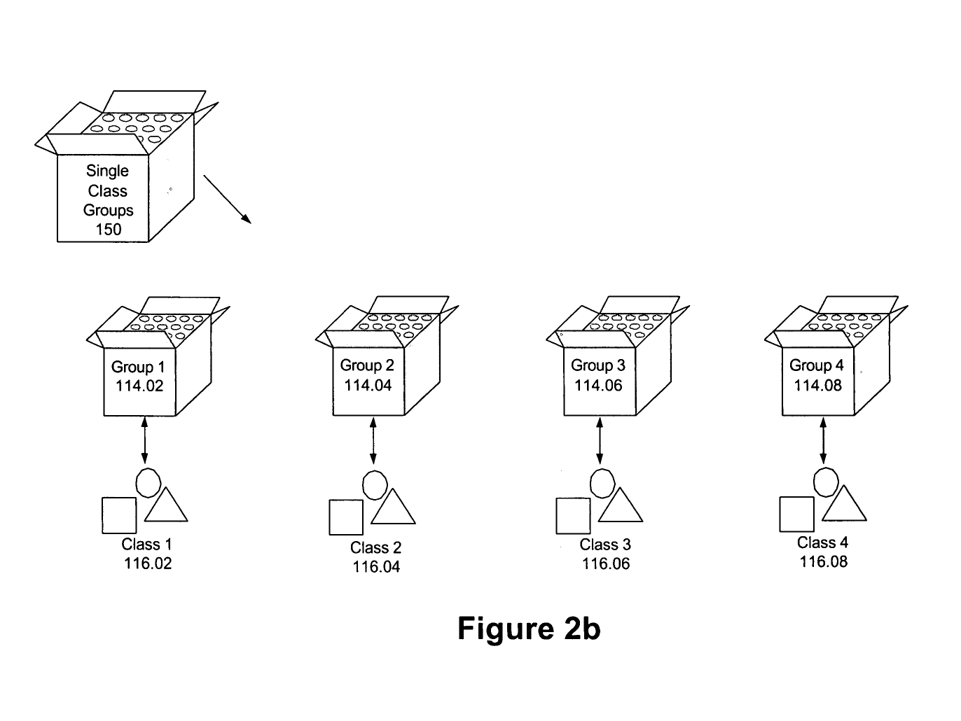

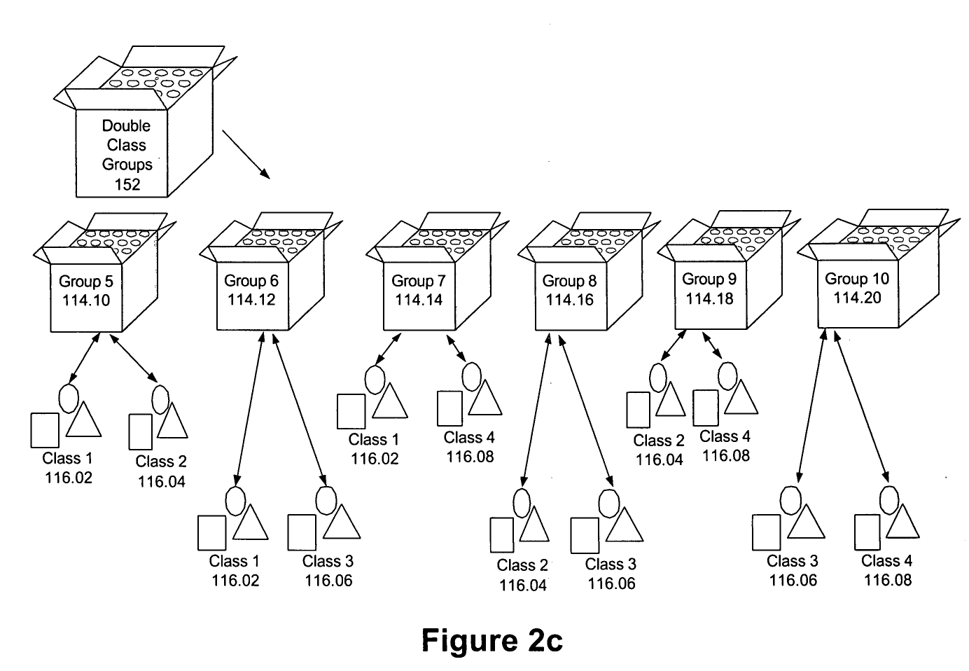

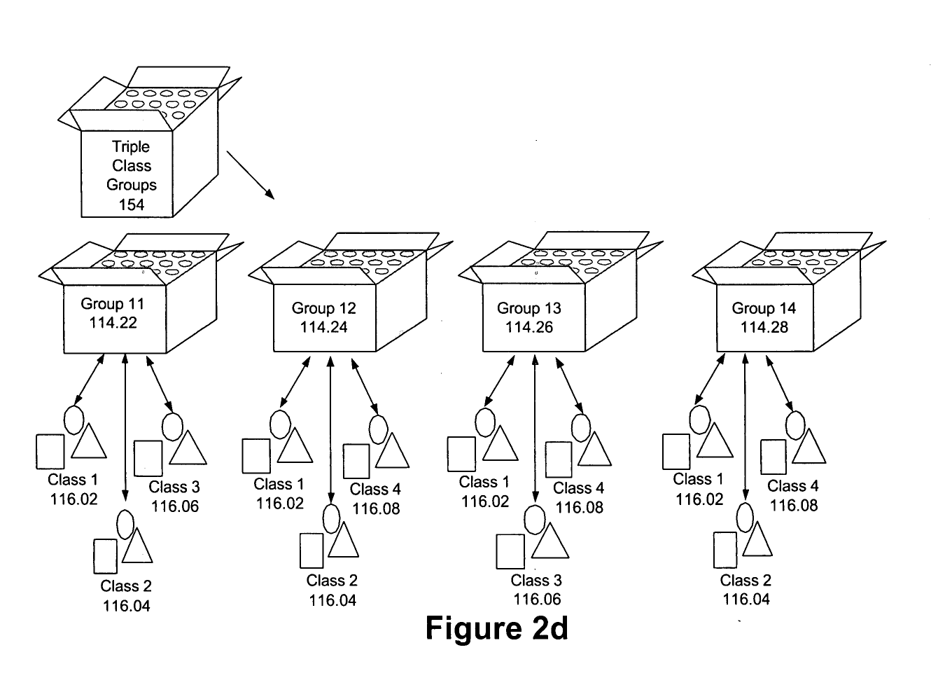

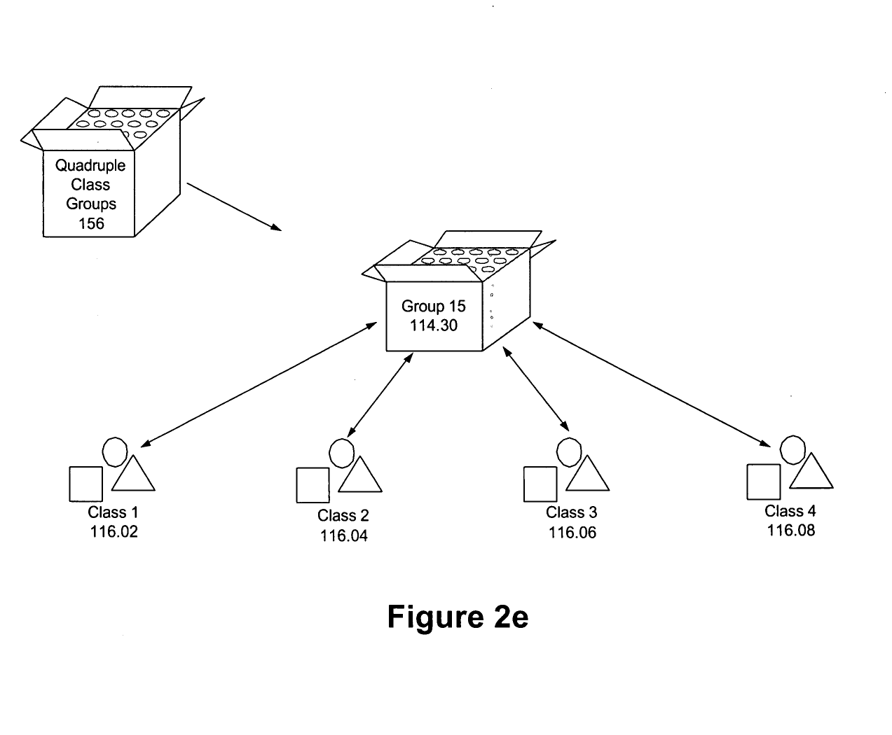

FIG. 2a is a hierarchy diagram illustrating one example of the different types of groups 114 that can be incorporated into the processing performed by the classification system 100. One group 114 can be distinguished from one another group 114 based on the classes 116 that are associated with the particular group 114. Different groups 114 can also be distinguished from one another on the basis of group-type, a characteristic that is based on the number of classes 116 that are associated with groups 114 of the particular group-type.

For the purposes of the examples disclosed in FIGS. 2a through 2e, a fully normalized group/class configuration 112 that includes four classes 116 is incorporated into the system 100. As discussed below, a fully normalized group/class configuration 112 is a configuration 112 that includes a group 114 for every possible combination of classes 116 (e.g. X²−1 groups, where X=the number of classes). In a preferred embodiment, no group 114 has the exact same combination of classes 116 as any other group 114 in the group/class configuration 112. For example, only one group 114 should include all of the available classes 116. These groups 114 can comprise what is termed the power set in mathematics. At each level of grouping (e.g. single classes, pairs of class, etc.) the number of groups 114 at each level can be given by the term:

$$( \begin{matrix}N \\ k\end{matrix} )$$

where N is the total number of elements and k is the number being grouped together, with k values ranging from 1 through N.

As illustrated in FIG. 2a, a group/class configuration 112 of four classes 116 means that there are four different group types, including: a single class group type 150 (groups 114 that include only one class 116); a double class group type 152 (groups 114 that include two classes 116); a triple class group type 154 (groups 114 that include three classes 116); and a fourth class group type 156 (groups 114 that include all four classes 116).

B. Different Group Types

1. Single-Class Groups

FIG. 2b is a hierarchy diagram illustrating various examples of groups 114 of the single-class group type 150 that can be incorporated into the processing performed by the classification system 100. In an embodiment with four classes 116 (class 1, class 2, class 3, and class 4}, there are four single-class groups 114. A group 1 (114.02) consists of class 1 (116.02), a group 2 (114.04) consists of class 2 (116.04), a group 3 (114.06) consists of class 3 (116.06), and a group 4 (114.08) consists of class 4 (116.08).

2. Double-Class Groups

FIG. 2c is a hierarchy diagram illustrating various examples of double-class groups 152 that can be incorporated into the processing performed by the classification system 100. In an embodiment with four classes 116 {class 1, class 2, class 3, and class 4}, there are six double-class groups 114. A group 5 (114.10) that includes class 1 (116.02) and class 2 (116.04); a group 6 (114.12) that includes class 1 (116.02) and class 3 (116.06); a group 7 (114.14) that includes class 1 (116.02) and class 4 (116.08); a group 8 (114.16) that includes class 2 (116.04) and class 3 (116.06); a group 9 (114.18) includes class 2 (116.04) and class 4 (116.08); and a group 10 (114.20) that includes class 3 (116.06) and class 4 (116.08).

3. Triple-Class Groups

FIG. 2d is a hierarchy diagram illustrating various examples of triple-class groups 154 that can be incorporated into the processing performed by the classification system 100. In an embodiment with four classes 116 {class 1, class 2, class 3, and class 4}, there are four double-class groups 114. A group 11 (114.22) that includes class 1(116.02), class 2 (116.04), and class 3 (116.06); a group 12 (114.24) that includes class 1(116.02), class 2 (116.04), and class 4 (116.08); a group 13 (114.26) that includes class 1 (116.02), class 3 (116.06), and class 4 (116.08); and a group 14 (114.28) that includes a class 1(116.02), a class 2 (116.04), and a class 4 (116.08).

4. Quadruple-Class Groups

FIG. 2e is a hierarchy diagram illustrating an example of a quadruple-class group 156 (“group 15” in the example) that can be incorporated into the processing performed by the classification system 100. In an embodiment with four classes 116 {class 1, class 2, class 3, and class 4}, there is one quadruple-class group 114 that includes all of the available classes 116.

Regardless of the number of classes 116, there is always the possibility of including a group 114 that consists of each and every class 116. Such a group 114 represents a determination that the system 100 has not basis for making a decision and that the classification is essentially “unknown” and that the system 100 is in a temporary state of “ignorance.”

C. Safety Restraint Application Classes

Different embodiments of the system 100 can involve different numbers of classes 116 and groups 114. In a preferred embodiment of a vehicle safety restraint application, the classes 116 include the class of an adult, the class of a child, the class of a rear-facing infant seat, and the class of an empty seat.

1. RFIS Class

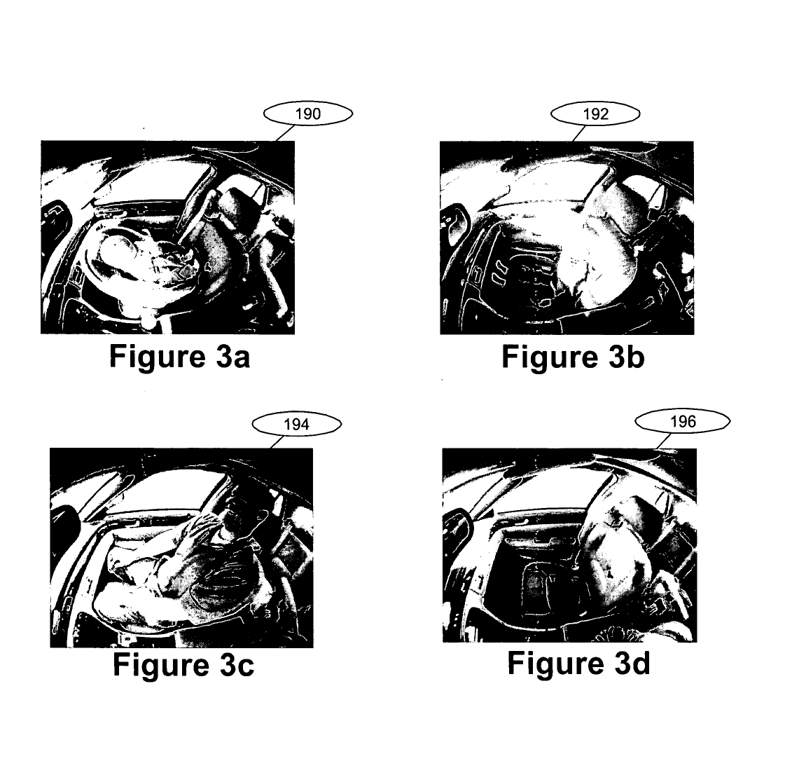

FIG. 3a is a diagram illustrating an example of a rear-facing infant seat (RFIS) class 190 in a vehicle safety restraint application embodiment of the classification system 100.

2. Child Class

FIG. 3b is a diagram illustrating an example of a child class 192 in a vehicle safety restraint application embodiment of the classification system 100.

3. Adult Class

FIG. 3c is a diagram illustrating an example of an adult class 194 in a vehicle safety restraint application embodiment of the classification system 100.

4. Empty Class

FIG. 3d is a diagram illustrating an example of an empty class 196 in a vehicle safety restraint application embodiment of the classification system 100.

### Subsystem-Level Views

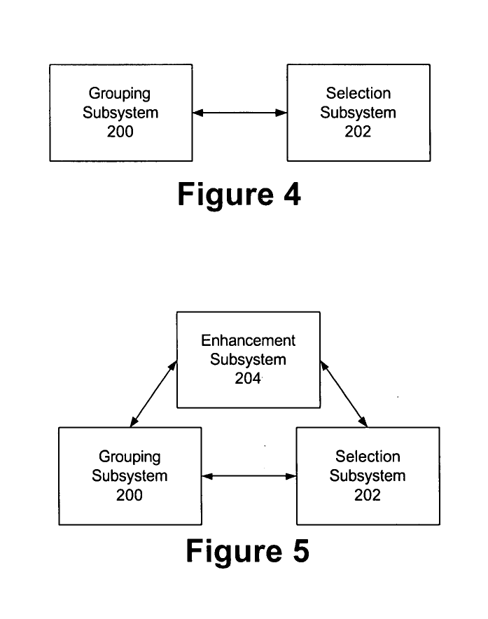

FIG. 4 is a block diagram illustrating an example of a subsystem-level view of an embodiment of the classification system 100. As disclosed in the Figure, the classification system 100 can include a grouping subsystem 200 for interacting with the group/class configuration 112, and a selection subsystem 202 for generating classifications 110.

A. Grouping Subsystem

A grouping subsystem 200 can be used to create, delete, update, and implement group/class configurations 112. The grouping subsystem 200 and the group/class configuration 112 allow the system 100 to implement a wide variety of different groups 114 and classes 116 defined for the purposes of generating useful classifications 110 for the various applications invoking the classification system 100. Different embodiments of the system 100 can involve a wide variety of different group/class configurations 112. However, there are some similar design principles that can be useful to a wide variety of different classification systems 100. For example, the ability of the system 100 to handle close call situations can be enhanced by a group/class configuration 112 that includes multi-class groups 114 that include combinations of potentially “similar” or “related” classes. For example, if it is difficult for the system 100 to confidently distinguish between a RFIS and a child, then it is probably a good idea to have a group 114 that includes the classes 116 of RFIS and child. Another generally desirable design consideration is that single-class groups 150 are desirable because in instances where the decision is not a close call, the system 100 can generate the most granular level of classification 110, and this may be of importance to the application utilizing the classification information.

In a preferred embodiment, the grouping subsystem 200 includes at least one group 114 that includes two or more classes 116, and each class 116 is included in at least one group 114. In an attempt to fully maximize the possibilities provided by set theory techniques known in the mathematical arts, the grouping subsystem 100 can utilize a group/class configuration 112 that includes all possible combinations of groups 112. Such a configuration 112 can be referred to as a fully normalized configuration 112 because such a configuration 112 allows the system 100 to make processing distinctions with respect to any distinction to which the group/class configuration 112 is capable of representing. FIGS. 2a, 2b, 2c, 2d, and 2e illustrate such an example fully normalized group/class configuration for a class library that is made up of four classes 116. A fully normalized group/class configuration will result in X²−1 groups, where X represents the number of classes 116. Thus, a fully normalized embodiment a configuration 112 consisting of four classes 116 will have (4²−1)=15 groups as is illustrated in FIGS. 2a-2e. As the number of classes 116 increases, it becomes increasingly cumbersome to implement a fully normalized group/class configuration 112. In those situations, it may be necessary to pick and choose the combinations of classes 116 that provide the most “bang for the buck” given the goals of the application utilizing the system 100.

In a preferred embodiment, the groups 114 and classes 116 of the grouping subsystem 200 are predefined before the classification system 100 is implemented in conjunction with the appropriate application. However, in some alternative embodiments, it may be desirable to define groups 114 and/or classes 116 dynamically. This allows close call situations to be identified through empirical data, instead of the predictions or even educated guesses.

B. Selection Subsystem

A selection subsystem 202 is used to determine the classification 110 that best describes the target attributes 106 captured by the sensor 104. As indicated by the arrows in the Figure pointing towards and away from the selection subsystem 202, the processing of the selection subsystem 202 can be influenced by the grouping subsystem 200, and the selection subsystem 202 can in certain circumstances, influence the processing of the grouping subsystem 200. One potential example of the selection subsystem 202 impacting the grouping subsystem 200 is the dynamic definition or modification of the group/class configuration 112, as discussed above.

Different embodiments of the system 100 can invoke different classification heuristics 118 with different inputs and different degrees of sensitivity, data integration, volatility, accuracy ranges, and other characteristics. Examples of factors that can influence the functionality of the selection subsystem 202 include but are not limited to: a prior classification 110 or determination made by the system 100; an event flag 133 representing the occurrence of some event relevant to the logic of the classification heuristics 118, such as the opening of a door in a vehicle safety restraint embodiment; a belief metric 124; a plausibility metric 128; a context metric 132 representing some information outside the scope of the target attributes 106 captured by the sensor 104; various probability metrics 120, such as an incoming probability mass metric and a past probability mass metric; and various historical attributes.

The importance of historical attributes 134 can increaser in close call situations, or in the context of where the sensor reading capturing the target attribute 106 is relatively poor, offering indeterminate or unreliable information for the vector of features. In a situation of temporary sensor failure, the selection subsystem 202 can even be configured to rely in total upon the most recent classification 110.

C. Enhancement Subsystem

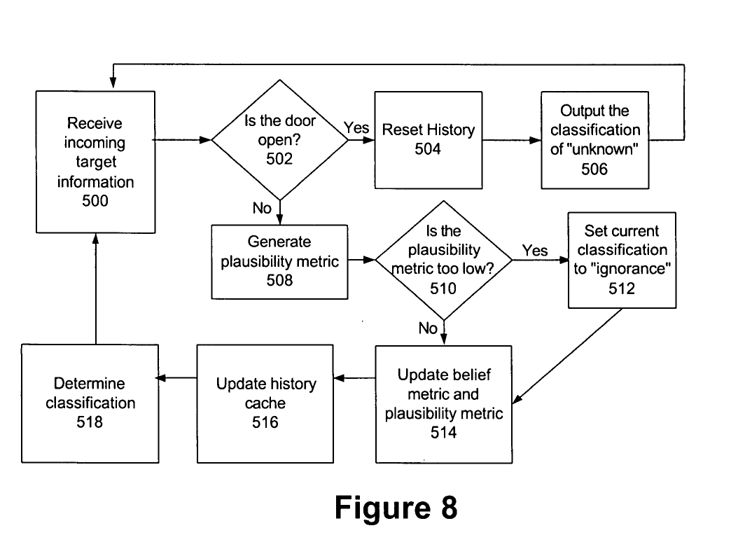

FIG. 5 is a block diagram illustrating an example of a subsystem-level view of an embodiment of the classification system 100 that includes an enhancement subsystem 204. As discussed in greater detail below and as illustrated in FIG. 8, the system 100 can generate classifications 110 by repeatedly: (a) capturing raw sensor information; (b) generating “initial” classifications 110; (c) calculating belief metrics 124, plausibility metrics 128, context metrics 132, (d) accessing historical attributes 134; and (e) using some or all of the relevant information above for generating “final” classifications 110. “Final” classifications 110 are typically not truly final, because in many classification systems 100, the process begins again with the capture of new target attributes 106, and the generating of yet another “initial” classification 110, and so on and so forth.

The functionality related to generating a “final” classification 110 from the various inputs that include the “initial” classification can be performed by the enhancement subsystem 204. In some embodiments of the system 100 that include the enhancement subsystem 204, the processing performed by the selection subsystem 202 could be limited to existing prior art classifier heuristics 118, and the processing of the belief heuristics 122, plausibility heuristics 126, context heuristics 130, event flags 132, and historical attributes 134 can be limited to the enhancement subsystem 204.

The enhancement subsystem 204 can utilize a different group/class configuration 112 than the configuration 112 used by the selection subsystem 202. For example, it may be less desirable to use a full normalized configuration 112 in the context of a “final” classification 110 than in the context of the “initial” classification 110 since the “final” classification 110 will likely be subjected to greater scrutiny and corresponding influence by historical attributes 134, event flags 132, plausibility metrics 128, belief metrics 124, and context metrics 132.

### Process-Flow Views

A. Classification Process

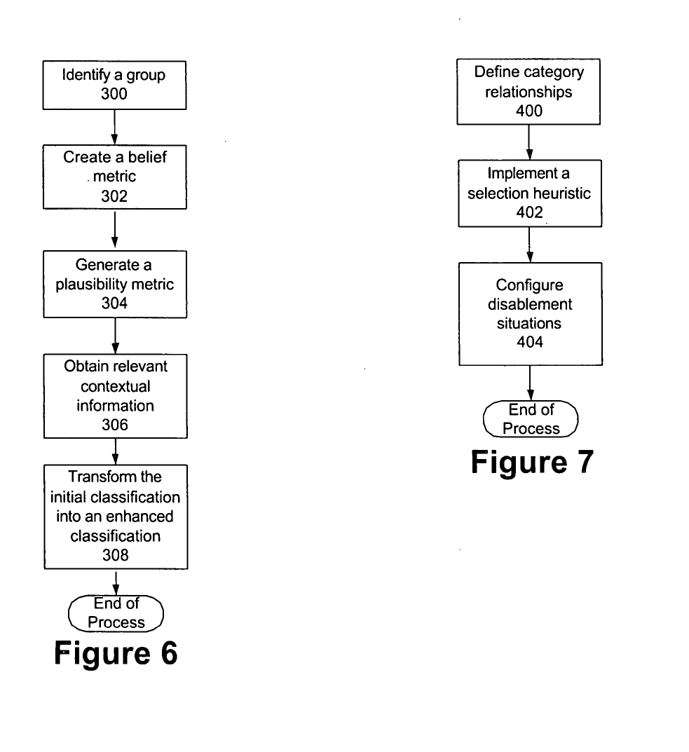

FIG. 6 is flow chart diagram illustrating an example of a process for classifying target information 106 that is captured by a sensor 104.

At 300, a group 114 is tentatively identified as the initial classification 110 using one or more of the classification heuristics 118 discussed above and below. The identified group 114 can be associated with anywhere between 1 and X classes, where X is the total number of classes 116 in the group/class configuration 112. In a preferred embodiment, the group 114 tentatively identified as the initial classification 110 is the group 114 that is associated with the highest probability metric 120. In many embodiments, a probability metric 120 is generated for each group 114 in the group/class configuration 112.

At 302, a belief metric 124 is a quantitative measurement representing the support or confidence that exists for a particular “initial” classification 110. In a preferred embodiment, a separate and distinct belief metric 124 is generated for each group 114 in the group/class configuration 112. Belief metrics 124 can be calculated by a belief heuristic 122. In some embodiments, the belief metric 124 is a belief interval, an interval that is defined by both the belief metric -124 and the plausibility metric 126. If the particular embodiment utilizes a belief interval, the plausibility portion of the interval is generated at 304 as described below.

At 304, a plausibility metric 126 is generated. The plausibility metric 126 is a quantitative measurement that relates to the belief metric 124. The plausibility metric 126 is indicative of the plausibility of a particular belief. The plausibility metric 126 incorporates the relative likelihood or unlikelihood of a particular transition from one class to another class. For example, if the implementers of the system 100 determine that a transition from an adult class to a RFIS class is an improbable event, the plausibility metric 126 can factor that into the plausibility of an RFIS classification 110 in the context of a history where a prior classification 110 merely 2 seconds old was that of an adult.

At 306, the system 100 obtains relevant contextual information. This information need not originate from the sensor 104. For example, other environmental conditions or events can make certain assumptions or presumptions more or less valid.

At 308, the system 100 transforms the “initial” classification 110 into a “final” classification 110 using the various metrics generated above. A variety of different classification metrics and/or combinations of classification metrics can be used to perform this step. The process then ends, although in many embodiments of the system 100, the processing from 300 through 308 repeats.

B. Process for Implementing a Classification System in

FIG. 7 is a flow chart diagram illustrating an example of a process for implementing the classification system 100 in the context of a vehicle safety restraint application.

At 400, the various category relationships making up the group/class configuration 112 are defined. This can include defining which groups 114 are affiliated with which classes 116, and the defining characteristics for the various classes 116. The group/class configuration 112 is typically implemented in the form of a data design supported by the processor 108.

At 402, the one or more classification heuristics 118, including potentially belief heuristics 124, plausibility metrics 126, and context heuristics 130, are implemented or installed into the processor 108 used to support the system 100. This step is typically performed by loading programming logic or other forms of instructions onto the processor 108.

At 404, the vehicle safety restraint application is configured with respect to disablement decisions. Certain classifications 110 can result per se in a disablement of the deployment of the safety restraint. Other classifications 110 may result in a more multi-factored test with regards to disablement. For example, if there is reason to suspect that the classification 110 is not suitable for the deployment of the safety restraint, this information can be incorporated into the decision-making process with respect to whether the impact of an accident is significant enough to justify the deployment of the safety restraint. Different vehicles may involve different rules with regards to the disablement decisions, and the level of plausibility required to support the altering of an application's functionality on the basis of information provided by the system 100. A single embodiment of the system 100 may render certain classes 116 per se disablement decisions while other classes 116 result in a more contextual analysis involving additional data integration.

C. Detailed Process Flow of a Safety Restraint Embodiment

FIG. 8 is a flow chart diagram illustrating a detailed example of the classification system 100 in a vehicle safety restraint application embodiment.

At 500, the system 100 receives incoming target information 106. The contents of the target information 106 can vary from embodiment to embodiment. In some implementations, the information received at 500 can include: a tentative, initial, or interim classifications (collectively “initial classifications” 110) generated by one or more classification heuristics 118; one or more probability metrics 120 corresponding to the one or more initial classifications 110, as well as raw target information such as target attributes 106. In other embodiments, the target information received at 500 can be limited to the raw information captured by the sensor 104. Other implementations may involve substantially fewer inputs, potentially limited to the raw information captured by the sensor 104.

At 502, the system 100 determines whether or not a door corresponding to the location of the occupant is open. The opening of a door is an example of an event that can be detected, and result in the setting of an event flag 133 as discussed above. Different vehicle safety restraint embodiments may include different types of event flags 132. Similarly, non-safety restraint and non-vehicle embodiments can also include a wide variety of different events for the purpose of identifying various contextual and environmental factors that are relevant to making accurate classifications 110. Alternative embodiments of the system 100 may check for a different event at 502. In some embodiments of the system 100, the sensor 104 providing the target attributes 106 to the system 100 is not the same device that detects the occurrence of the event, or results in the setting of the event flag 133. For example, a mechanism within the door could be used to determine whether or not the door is open, while a video camera could be used to capture the attribute information 106 used by the system 100 to generate classifications 110. In other embodiments, the same sensor 104 used to capture target attributes 106 is also used to identify the occurrence of events, such as the opening of a door. For example, an image of the interior of the vehicle could potentially be used to determine whether or not the door is currently open.

If the system 100 at 502 determines that the door is in a state of being open, the system 100 can reset history information at 504. This is appropriate because the opening of the door often results in a change of passengers, and thus the system 100 should no longer rely on past data. In alternative embodiments, the system 100 may refrain from actually deleting the history information and instead simply sharply discount the history information to take into consideration the high likelihood that the occupant of the seat has changed. If historical information is to be removed, a history cache component of the processor can be flushed or deleted.

With the deleting of history information at 504, the classification 110 at 506 is temporarily set to the “unknown” or “all” group, the group 114 that includes all of the classes 116. In an embodiment where all history is not deleted at 504, it may still be useful to temporarily set the classification 110 at 506 to “unknown” or “all” because it will force the system 100 to take a fresh look at the target attributes 106 captured after the door opening event. After the classification 110 is set at 506 in accordance with the “door open” or other event flag 133 (in a preferred embodiment, the classification at 506 is set to the group 114 that includes all classes 116), the system 100 receives new sensor readings at 500 and the processing loop begins once again.

If the door is not open at 502 (or if the appropriate event flag 133 has not been set to an affirmative value), then the system 100 invokes one or more plausibility heuristics 126 to generate at 508 one or more plausibility metrics 128 as discussed above. In a preferred embodiment, Equation 4 and Equation 5, as illustrated above, are used to generate the plausibility metric 128 for the various groups 114. The plausibility heuristic 126 is used to determine the plausibility of changes between classifications 110. Plausibility heuristics 126 can be configured to preclude certain transitions, merely impede other transitions, while freely allowing still other potential transitions. Thus, the configuration of plausibility heuristics 126 are highly dependent upon the particular group/class configuration 112 incorporated into the processing performed by the system 100. For example, a large child or small adult may transition back and forth between the classifications 110 of child and adult with some regularity depending on their seating posture. Therefore, the plausibility heuristics 126 should be configured to freely permit such transitions. In contrast, it is highly unlike that an adult will transition to a RFIS. Thus, the system 100 should be at least somewhat skeptical of such a transition. However, it is possible that the classification system 100 and the one or more classification heuristics 118 got the initial classification 110 wrong because the adult was in a curled up position in the seat and then sat upright.

The most recent classification 110 can be applied to a Dempster-Shafer combiner, and this updated belief set is compared to the prior belief set generated before the most recent target information 106 was collected at 500. If the sum of the absolute differences in beliefs over all of the groups exceeds a threshold value then the incoming data is deemed implausible. The plausibility threshold value is preferably predefined, but it can in some embodiments, be set dynamically based on the prior performance of the system 100. By comparing the plausibility metric 128 with the plausibility threshold value, beliefs (as measured in the belief metric 124) in the classification 110 are slowly reduced. Over time, if the incoming classifications 110 are deemed implausible, the belief or confidence in whatever the previous classification 110 is also becomes less certain, which is a desirable impact. At some point, the belief metric 124 for any classification 110 is so low that the new incoming classification 110 is considered plausible due to the lack of any strong beliefs about the past.

At 512, the process of reducing belief is carried out by replacing the current classification 110 with the result of complete ignorance, given the implausibility identified at 510.

At 514, the belief metric 124 and plausibility metric 128 for each group 114 under consideration is updated. In a preferred embodiment, the belief metrics 124 and plausibility metrics 128 are updated using the Dempster-Shafer rules relating to evidence combination. Those rules can be embodied in Equations 1-5, as illustrated above.

In a preferred embodiment, the value of the belief interval, which includes both the belief metric 124 and the plausibility metric 128 measures the true belief in the current classification 110 in the eyes of the system 100. The use of an interval differs from traditional Bayesian probability techniques, which would result in a single value. The meaning of the belief metric 124 is the sum of all the evidence that directly supports the decision A or classification A, as illustrated in Equations 1-5. Similarly, the plausibility metric 128 represents the sum of all the evidence that does not directly refute the belief that group A is the appropriate classification 110.

At 516, the history cache is updated in light of the processing at 514. Once the new belief metrics 124 and plausibility metrics 128 are computed for each group 114, they are preferably stored in a first-in-first-out buffer of historical attributes 106. The buffer is preferably maintained to hold between five (5) and ten (10) historical “rounds” or “samples” of target attributes 106 and/or classifications 110 with the accompanying metrics such as belief and plausibility (contextual information can also be stored if desired). As new information is captured and stored, the oldest “round” or “sample can then be deleted.

At 518, the system 100 generates the latest determination of the appropriate classification 110 for the target 102 represented by the various target attributes 106. The system 100 invokes one or more classification heuristics 118 for generating the updated classification 110. Such a heuristic 118 preferably incorporates the information belief metric 124 and the plausibility metric 120 within the stored historical attributes 134 (residing in a history cache for the processor 108) for each of the groups 114 in the group/class configuration 112.

There are a number of different classification heuristics 118 that cane be used to generate classifications 110, from a simple averaging, to a time-weighted average where the most recent data is the most heavily weighted, to a Kalman filter approach where the data is processed in a recursive approach that incorporates into the “final” classification 110, potentially all historical attributes 134.

Once the processing by one of the above methods is performed (or any other method for updating the classification 110 of the target 102), the system 100 can output classifications as being one of the following: {RFIS, child}, {adult}, or {empty}. This allows the system 100 to perform dynamic suppression on adults and suppress on the other classes 116. It is also possible for some cases where the system 100 only disables on RFIS and enables the system 100 to track on any other occupant than the two groups.

Some embodiments of the system 100 may be configured to only allow deployment of the safety restraint application when the occupant is an adult. All other classes 116 and groups 114 disable the deployment of the safety restraint. In such an embodiment, the two monitored groups 114 would be {adult} and {RFIS, child, empty}.

In any of the different embodiments identified above, the “final” classification is the monitored group 114 where the average of the belief metric 122 and plausibility metric 126 are the highest.

The processing disclosed by FIG. 8 can be performed once in some embodiments of the system 100, but in a preferred embodiment, the processing repeats. For a safety-related function such as a safety restraint application, it is beneficial for the new classifications to be generated repeatedly, with only a short period of time between the different classifications 110 and the different sensor readings.

### Alternative Embodiments

While the invention has been specifically described in connection with certain specific embodiments thereof, it is to be understood t,hat this is by way of illustration and not of limitation, and the scope of the appended claims should be construed as broadly as the prior art will permit. Given the disclosure above, one skilled in the art could implement the system 100 in a wide variety of different embodiments, including vehicle safety restraint applications, security applications, radiological applications, navigation applications, and a wide variety of different contexts, purposes, and environments.

1. A classification system for generating a classification of target information obtained with a sensor, said classification system comprising:
a grouping subsystem, said grouping subsystem providing for a plurality of classes and a plurality of groups, wherein each said group includes at least one said class, and wherein at least one said group includes more than one said class; and
a selection subsystem, wherein said selection subsystem provides for generating said classification using said target information, wherein said classification is one said group from said plurality of groups.

2. The system of claim 1, wherein said selection subsystem further provides for a prior determination, wherein the generating of said classification by said selection subsystem is influenced by said prior determination.

3. The system of claim 1, wherein said selection subsystem further provides for a event flag, wherein the generating of said classification by said selection subsystem is influenced by said event flag.

4. The system of claim 3, wherein said target information is not used to set said event flag.

5. The system of claim 1, wherein said plurality of groups further includes:
a first group, said first group comprising a first class; and
a second group, said second group comprising said first class and a second class.

6. The system of claim 5, wherein said plurality of groups further includes a third group, said third group comprising said first class, said second class, and a third class.

7. The system of claim 1, wherein said plurality of groups and said plurality of classes are predefined before said target information is obtained.

8. The system of claim 1, said selection subsystem further providing for a belief metric, wherein said belief metric influences the classification generated by said selection subsystem.

9. The system of claim 1, said selection subsystem further providing for a plausibility metric, wherein said plausibility metric influences the classification generated by said selection subsystem.

10. The system of claim 1, said selection subsystem further providing for a plurality of probability metrics, wherein each group in said plurality of groups is associated with at least one probability metric from said plurality of probability metrics, and wherein said plurality of probability metrics influences said classification generated by said selection subsystem.

11. The system of claim 1, said selection subsystem further providing for an incoming probability mass and a past probability mass, wherein said incoming probability mass and said past probability mass influence the classification generated by said selection subsystem.

12. The system of claim 1, said selection subsystem further providing for:
a plurality of incoming probability mass metrics, wherein each said group is associated with at least one said incoming probability mass metric;
a plurality of past probability mass metrics, wherein each said group is associated with at least one said past probability mass metric;
a plurality of belief metrics, wherein each said group is associated with at least one said belief metric;
a plurality of plausibility metrics, wherein each said group is associated with at least one said plausibility metric; and
wherein at least one said probability mass metric, at least one past probability mass metric, at least one said belief metric, and at least one said plausibility metric influence the classification generated by said selection subsystem.

13. The system of claim 1, further comprising vehicle information, occupant information, a safety restraint application, and a disablement decision, wherein the target information relates to said occupant information located in said vehicle, wherein said selection subsystem system is configured to make said classification accessible to said safety restraint application, and wherein said classification influences said disablement decision.

14. The system of claim 13, further comprising an event and a reset history flag, wherein said reset history flag is set in accordance with said event, and wherein said selection subsystem generates said classification using said reset history flag.

15. The system of claim 14, further comprising information concerning an opening of a door, wherein said event is said opening of said door.

16. The system of claim 13, wherein said plurality of classes includes an RFIS, a child, and an adult.

17. The system of claim 1, wherein the target information is captured from an image-based sensor.

18. The system of claim 1, further comprising an enhancement subsystem and an enhanced classification, wherein said enhancement subsystem generates said enhanced classification from said classification, and wherein said enhanced classification includes only one said class.

19. The system of claim 18, further comprising a historical attribute, wherein said historical attribute influences said enhanced classification generated by said enhancement subsystem.

20. The system of claim 1, further comprising a belief metric and a plausibility metric, wherein said selection subsystem generates said classification using said belief metric and said plausibility metric.

21. The system of claim 1, said selection subsystem further providing for a belief metric and a plausibility metric, wherein said metrics influence the classification generated by said selection subsystem.

22. A classification system for generating a classification from a plurality of target attributes obtained with a sensor, said classification system comprising:
a processor, said processor providing for:
a classification;
a plurality of historical attributes;
a plurality of groups;
a plurality of classes;
a plurality of belief metrics; and
a plurality of plausibility metrics;
wherein each said group includes at least one said class;
wherein at least one said group includes more than one said class;
wherein said classification is one group within said plurality of groups; and
wherein said processor identifies said using at least one said historical attribute, at least one said belief metric, and at least one said plausibility metric.

23. The classification system of claim 22, further comprising an event and a reset history flag, wherein said processor is configured to set said reset history flag in response to said event, wherein said processor deletes at least one said historical attribute upon the setting of said reset history flag to a value of yes.

24. The system of claim 23, further comprising an opening of a door, wherein said event is said opening of said door.

25. The classification system of claim 22, further comprising a disablement decision concerning a safety restraint application, wherein said sensor is said video camera, wherein said plurality of classes includes a child, a RFIS, and an adult, and wherein said classification is configured to be accessed by said safety restraint application in generating said disablement decision.

26. The system of claim 22, wherein said plurality of groups includes:
a first group, said first group comprising a first class;
a second group, said second group comprising said first class and a second class;
a third group, said third group comprising said first class, said second class, and a third class; and
a fourth group, said fourth group comprising said first class, said second class, said third class, and a fourth class.

27. A method for classifying a target using information obtained from a sensor, said method comprising:
identifying one group from a plurality of predefined groups as an initial classification by analyzing the target information;
creating a belief metric relating to the initial classification
generating a plausibility metric relating to the initial classification and the belief metric; and
transforming the initial classification into an enhanced classification, wherein the belief metric and the plausibility metric influence the transformation of the initial classification into the enhanced classification.

28. The method of claim 27, further comprising:
detecting a predefined event;
storing enhanced classification data in a history cache until the predefined event is detected; and
clearing the history cache upon the detection of the predefined event.

29. The method of claim 27, further comprising:
selectively setting an ignorance flag by comparing the plausibility metric to a predefined threshold value; and
selectively generating an initial classification to a group that comprises all classes upon the setting of the ignorance flag to a value of yes.

30. The method of claim 27, wherein the plurality of groups includes a plurality of classes, wherein each group includes at least one class, wherein at least one group includes at least two classes, and wherein each class is represented in at least one group.

31. The method of claim 30, wherein the group associated with the initial classification includes at least two classes.

32. A method of implementing an occupant classifier for use in a vehicle safety restraint application, comprising:
defining a disablement situation, a plurality of groups, and a plurality classes, wherein each group is defined to include at least one class, wherein at least one group is defined to include more than one class, and wherein at least one group is defined as the disablement situation;
implementing a selection heuristic to selectively identify one group within the plurality of groups as the classification, wherein the selection heuristic is configured to be influenced by a plausibility metric and a historical attribute; and
configuring the vehicle safety restraint application to preclude deployment when the identified group is defined as the disablement situation.

33. The method of claim 32, further comprising:
providing a processor that is configured to:
detect a predefined event;
store updated classification data in a history cache until the predefined event is detected; and
clear the history cache upon the detection of the predefined event.
